(19) United States
(12) Patent Application Publication
(10) Pub. No.: US 2023/0195530 A1
(43) Pub. Date: Jun. 22, 2023

(54) Systems and Methods for Balancing Loads Across Multiple Processing Cores of a Wireless Device

(71) Applicant: Apple Inc., Cupertino, CA (US)

(72) Inventors: Santosh Abraham, San Diego, CA (US); Vijay Venkataraman, San Jose, CA (US); Bobby Jose, San Diego, CA (US)

(21) Appl. No.: 17/951,031

(22) Filed: Sep. 22, 2022

Related U.S. Application Data
(60) Provisional application No. 63/291,272, filed on Dec. 17, 2021.

(51) Int. Cl. G06F 9/50; G06F 16/21

(52) U.S. Cl. CPC G06F 9/505; G06F 16/211

(57) ABSTRACT

In an example method, a system obtains a data packet for processing, determines a hash value representing the data packet, and selects a processor core from among a plurality of processor cores for processing the data packet. The processor core is selected by determining, based on the hash value, that the hash value corresponds to a first processor core from among the plurality of processor cores, and determining, based on a plurality of data structures stored by the load balancing system, whether to select the first processor core or a second processor core from among the plurality of processor cores for processing the data packet. Further, the system causes the selected processor core to process the data packet.

### CROSS-REFERENCE TO RELATED APPLICATIONS

This application claims priority to U.S. Application No. 63/291,272, filed on Dec. 17, 2021, which is hereby incorporated by reference in its entirety.

### TECHNICAL FIELD

The disclosure relates to systems and techniques for balancing loads across multiple processing cores of a wireless device, such as a user equipment device.

### BACKGROUND

Electronic devices can communicate with one another through a wireless network. As an example, a first electronic device can establish a wireless communications link, such as a cellular link, with a second electronic device. The first electronic device can transmit data to and/or receive data from the second electronic device via the wireless communications link.

### SUMMARY

Systems, methods, devices and non-transitory, computer-readable media are disclosed for balancing loads across multiple processing cores of a wireless device, such as a user equipment device.

In some aspects, a method includes: obtaining, by a system, a data packet for processing; determining, by the system, a hash value representing the data packet; selecting, by the system, a processor core from among a plurality of processor cores for processing the data packet, where selecting the processor core includes: determining, based at least in part on the hash value, that the hash value corresponds to a first processor core from among the plurality of processor cores, and determining, based on a plurality of data structures stored by the system, whether to select the first processor core or a second processor core from among the plurality of processor cores for processing the data packet; and causing, by the system, the selected processor core to process the data packet.

Implementations of this aspect can include one or more of the following features.

In some implementations, determining that the hash value corresponds to the first processor core can include: determining a portion of the hash value, and determining that the portion of the hash value corresponds to the first processor core.

In some implementations, the portion of the hash value can be a specified number of least significant bits of the hash value.

In some implementations, the portion of the hash value can be the least significant bit of the hash value.

In some implementations, the portion of the hash value can be the two least significant bits of the hash value.

In some implementations, determining whether to select the first processor core or the second processor core for processing the data packet can include: determining that the portion of the hash value corresponds to a first data position, and setting a first value at the first data position of a first data structure to 1, wherein the first data structure is selected from among the plurality of data structures.

In some implementations, determining whether to select the first processor core or the second processor core for processing the data packet can include: determining a second value at the first data position of a second data structure, wherein the second data structure is selected from among the plurality of data structures, and selecting the first processor core or the second processor core based on the second value.

In some implementations, determining whether to select the first processor core or the second processor core for processing the data packet can include: determining that the second value is 0, and responsive to determining that the second value is 0, selecting the first data processor core for processing the data package.

In some implementations, determining whether to select the first processor core or the second processor core for processing the data packet can include: determining that the second value is non-zero, and responsive to determining that the second value is non-zero, selecting the second data processor core for processing the data package.

In some implementations, determining whether to select the first processor core or the second processor core for processing the data packet can include: determining that a first utilization of the first processor core has exceeded a threshold value, and responsive to determining to that the first utilization of the first processor core has exceeded the threshold value, setting the second value at the first data position of the second data structure to 1.

In some implementations, the first utilization of the first processor core can be determined based on a number of data packets assigned by the system to the first processor core over a sliding time window.

In some implementations, the first utilization of the first processor core can be determined based on a windowed average of the number of data packets assigned by the system to the first processor core over the sliding time window.

In some implementations, the threshold value can vary based on a second utilization of the first processor core, where the second utilization corresponds to one or operations performed by the first processor core other than a processing of data packets.

In some implementations, the threshold value can be common to each of the processing cores.

In some implementations, the threshold value can be specific to a subset of the processing cores.

In some implementations, each of the processor cores can be associated with a respective threshold value. where the threshold value that is associated with each of the processor cores is determined based on a processing capability of that processor core.

In some implementations, the method can further include setting a third value at the first data position of a third data structure to 1, where the third data structure is selected from among the plurality of data structures.

In some implementations, the method can further include: periodically performing a first logical AND operation between the third data structure and the first data structure, and periodically performing a second logical AND operation between the third data structure and the second data structure.

In some implementations, the plurality of data structures can include a plurality of bit maps.

In some implementations, the plurality of data structures can include a plurality of data arrays.

In some implementations, the method can further include dynamically adjusting a size of at least some of the data arrays.

Other implementations are directed to systems, devices and non-transitory, computer-readable media including computer-executable instructions for performing the techniques described herein.

Particular implementations provide at least the following advantages. In some cases, the implementations described herein can be used to process data packets using a wireless device (e.g., a user equipment device) in an efficient and reliable manner.

As an example, a wireless device can include multiple processing cores for processing data packets received over a wireless network. For instance, upon receipt of a data packet, the wireless device can select one or more of the processing cores, and provide the data packet to the selected processing core (or cores) for processing. Due to differences in the processing time and/or receipt time of the data packets, each of the processing cores may experience different utilization at any given point in time. Using the systems and techniques described herein, the wireless device can dynamically assign data packets to specific ones of the processing cores, such that the utilization of the processing cores is more balanced between them (e.g., compared to the utilization that might be experienced absent performance of the implementations described herein). In some implementations, the systems and implementations described herein can reduce the likelihood that data packets are assigned to processing cores that are currently experiencing high utilization (e.g., processing cores that are currently unavailable to process new data packets and/or can only process new data packets according to a slow speed). Accordingly, the wireless device can process data packets more quickly, more reliably, and in a more efficient manner.

The details of one or more embodiments are set forth in the accompanying drawings and the description below. Other features and advantages will be apparent from the description and drawings, and from the claims.

### DESCRIPTION OF DRAWINGS

FIG. 1 is a diagram of an example system for exchanging data using a wireless network.

FIG. 2 is a diagram of an example load balancer.

FIG. 3 is a diagram of an example core selector of a load balancer.

FIGS. 4A-4F are diagrams of example operations performed using a load balancer and core selector.

FIG. 5 is a flow chart diagram of an example process for processing data packets using a communication device.

FIG. 6 is a block diagram of an example architecture for implementing the features and processes described in reference to FIGS. 1-5.

### DETAILED DESCRIPTION

Example systems and techniques for balancing loads across multiple processing cores of a wireless device, such as a user equipment device, and described herein.

In some implementations, a wireless device can include multiple processing cores for processing data packets received over a wireless network. For instance, upon receipt of a data packet, the wireless device can select one or more of the processing cores, and provide the data packet to the selected processing core (or cores) for processing.

Due to differences in the processing time and/or receipt time of the data packets, each of the processing cores may experience different utilization at any given point in time. Using the systems and techniques described herein, the wireless device can dynamically assign data packets to the processing cores such that the utilization of the processing cores is more balanced between them (e.g., compared to the utilization that might be experienced absent performance of the implementations described herein).

In some implementations, the systems and implementations described herein can reduce the likelihood that data packets are assigned to processing cores that are currently experiencing high utilization (e.g., processing cores that are currently unavailable to process new data packets and/or can only process new data packets according to a slow speed). Accordingly, the wireless device can process data packets more quickly, more reliably, and in a more efficient manner.

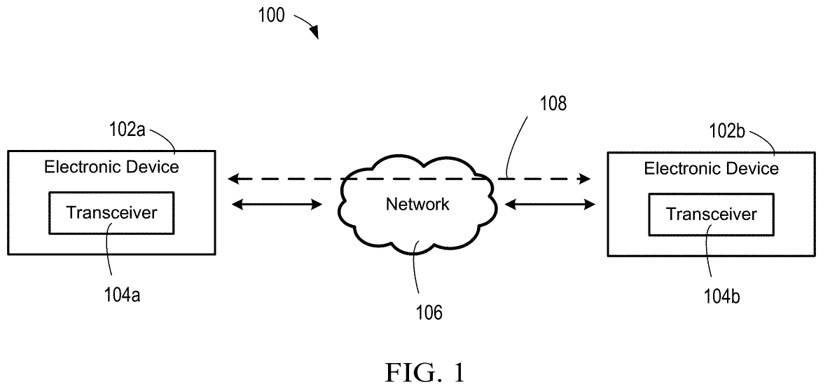

FIG. 1 shows an example system 100 for exchanging data using a wireless network. The system 100 includes a first electronic device 102a having a first wireless transceiver 104a, and a second electronic device 102b having a second wireless transceiver 104b.

In at least some implementations, the system 100 enables the electronic devices 102a and 102b to communicate with one another via one or more wireless communications links in a wireless network 106. As an example, using their wireless transceivers 104a and 140b, the electronic devices 102a can establish a one or more wireless communications links 108 between them. Further, the electronic devices 102a and 102b can transmit data to and/or receive data from one another via the wireless communications links 108 (e.g., by encoding the data in one or more signals, transmitting the signals wirelessly according to one or more wireless communications protocols, and decoding the signals to extract the data).

In practice, the electronic devices 102a and 102b can be any devices that are configured to receive, process, and transmit data. As an example, at least one of the electronic devices 102a or 102b can be a computing device, such as a client computing device (e.g., a desktop computer or a notebook computer), a server computing device (e.g., a server computer or cloud computing system), a mobile computing device (e.g., a cellular phone, smartphone, a tablet, a personal data assistant, or a notebook computer), a wearable computing device (e.g., a smart watch, a virtual reality headset, or an augmented reality headset), or other computing device capable of receiving, processing, and transmitting data. In some implementations, at least one of the electronic devices 102a or 102b can operate using one or more operating systems (e.g., Apple macOS, Apple iOS, Microsoft Windows, Linux, Unix, Google Android, etc.) and one or more architectures (e.g., x86, PowerPC, ARM, etc.). In some implementations, at least one of the electronic devices 102a or 102b can operate using a real-time operating system.

In some implementations, one of the electronic devices 102a and 102b can be a user equipment (UE) for communicating using the wireless network 106. A UE also may be referred to as a client device or mobile station). Further, another one of the electronic devices 102a and 102b can be a base station (BS) for the wireless network 106. A BS also may be referred to as a base transceiver station (BTS) or a network node.

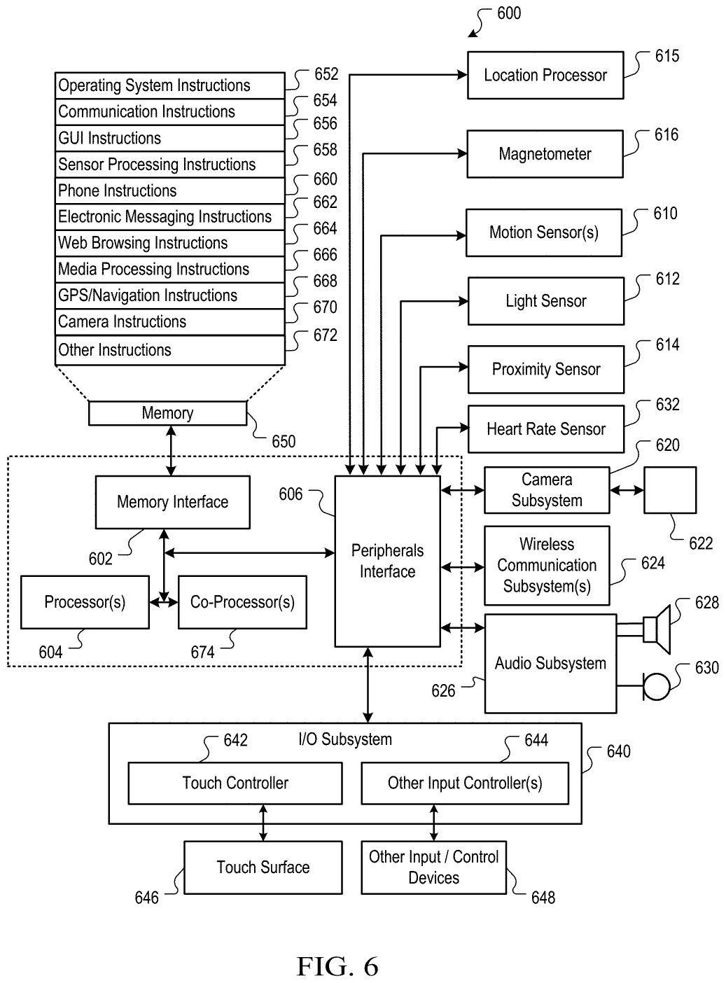

The wireless transceivers 104a and 104b can be configured to establish wireless communications links 108 in the wireless network 106, and transmit and receive data via those wireless communications links 108 according to any wireless communications protocol. In some implementations, the wireless transceivers 104a and 104b can be implemented using the wireless communications subsystems 624 described with reference to FIG. 6. Example wireless communications protocols include cellular communications protocols, such as a Global System for Mobile (GSM) protocol, a code-division multiple access (CDMA) protocol, a push-to-talk (PTT) protocol, a push-to-talk over cellular (POC) protocol, a Universal Mobile Telecommunications System (UMTS) protocol, a 3rd Generation Partnership Project Long-Term Evolution (3GPP LTE) protocol, a Fifth Generation (5G) protocol, a New Radio (NR) protocol, and/or any other cellular communications protocol. Other example wireless communications protocols include wireless local area network (WLAN) communications protocl, such as the Wi-Fi communications protocols (e.g., based on the Institute of Electrical and Electronics Engineers (IEEE) 802 family of standards).

Although FIG. 1 shows each of the electronic devices 102a and 102b having a single respective wireless transceiver 104a or 104b, in practice, each of the electronic devices 102a and 102b can have any number of transceivers. Further, although FIG. 1 shows two example electronic devices 102a and 102b, in practice, a system 100 can include any number of electronic devices that are interconnected with another via one or more wireless networks.

As described above, a wireless device (e.g., a user equipment device) can include multiple processing cores for processing data packets received over a wireless network. Further, upon receiving each data packet, the wireless device can dynamically assign the data packet to one of the processing cores such that the utilization of the processing cores is more balanced between them. In some implementation, this can be performed, at least in part, using a load balancer.

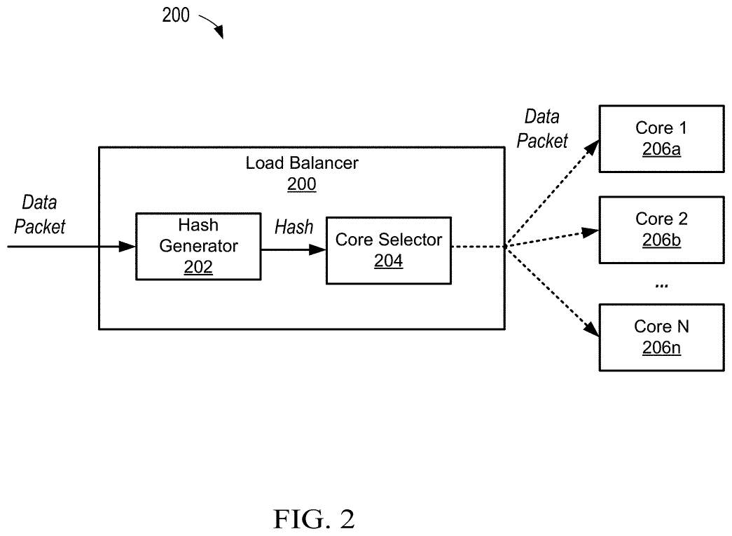

FIG. 2 shows an example load balancer 200. The load balancer 200 can be included, for example, in a transceiver of an electronic device (e.g., the transceiver 104a and/or the transceiver 104b), or as a discrete component separate from a transceiver. In some implementations, the load balancer 200 can included in a baseband processor of a wireless device (e.g., a baseband processor of a transceiver of a wireless device). The load balancer 200 includes a hash generator 202 and a core selector 204.

During an example operation of the load balancer 200, the hash generator 202 receives data packet (e.g., a data packet received from another electronic device via the network 106), and generates a hash based on the contents of the data packet. As an example, the hash generator 202 can be configured to generate hashes using a hash function, whereby at least a portion of the data packet is input into the hash function, and the output of the hash function is one of several fixed-sized values (e.g., hashes or has values). For instance, the hash generator 202 can be configured to generate a hash having a sequence of bits that represents the data packet. In some implementations, the hash function can generate hashes based, at least in part, on a Data Radio Barrier Identifier (DRB ID) associated with the data packet. In some implementations, the hash function can generate hashes based, at least in part, on an Internet Protocol (IP) 5-Tuple associated with the data packet (e.g., a set of five different values that make up a Transmission Control Protocol/Internet Protocol (TCP/IP) connection, including a source IP address and port number for the data packet, a destination IP address and port number, and the IP protocol in use). Example hash functions include the MD5 hash function, a Tiny HASH function, a CRC function, and a Toeplitz Hash function, among others.

In some implementations, the data packet can be one of several data packets in a data flow (e.g., a sequence of data packets). Further, the hash generator 202 can generate a hash that uniquely identifies that data flow from among other data flows. As san example, the hash generator 202 can generate a hash based, at least in part, on data fields of the data packet that identify the data flow (e.g., the DRB ID and/or IP 5-Tuple, as described above).

The hash generator provides the hash to the core selector 204. Based on the hash, the core selector 204 selects a processing core for processing the data packet. For instance, a wireless device can include N processing cores 206a-206n that are available for processing data packets. Based on the hash that is generated for a particular data packet, the core selector 204 can select one of the processing cores 206a-206n for processing that data packet. In some implementations, the core selector 204 can be configured such that each of the data packets of a particular data flow are assigned to the same processing core for processing. This can be beneficial, for example, in ensuring that the data packets of the same data flow are processed sequentially in time.

In some implementations, the wireless device can include, for each of the processing cores, a corresponding connection ring or connecting ring (CR) for interfacing with that processing core. Upon selecting a processing core for processing a data packet, the load balancer 200 can provide the data packet (or cause the data packet to be provided) to the connection ring or connecting ring (CR) corresponding to the selected processing core. In some implementations, the processing cores may be referred to as application process (AP) cores.

In general, the processing cores can be configured to perform various operations based on the data packets. As an example, the processing cores can be configured to extract data encoded in the data packets, and provide the extracted data to one or more processes (e.g., in an application layer of the electronic device) for further processing.

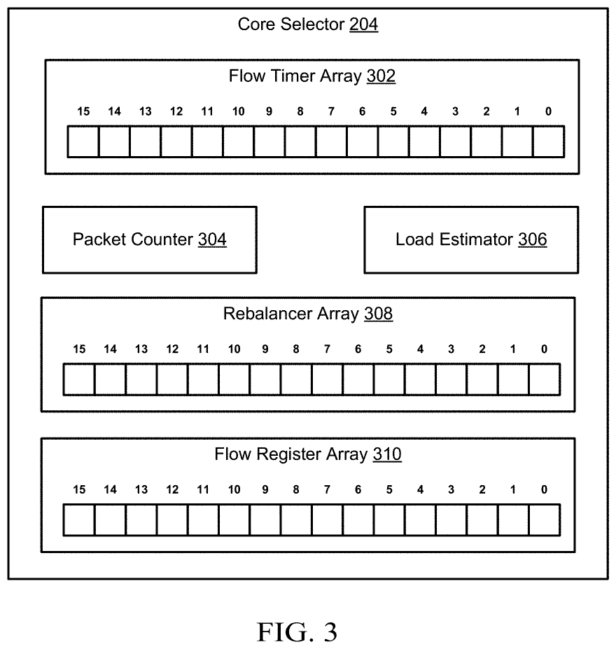

The core selector 204 is shown in greater detail in FIG. 3. The core selector 204 includes a flow timer array 302, a packet counter 304, a load estimator 306, a rebalancer array 308, and a flow register array 310. Each of these components are operated in conjunction to select a processing core for processing each data packet

In general, each of the flow timer array 302, the rebalancer array 308, and the flow register array 310 includes M memory locations for storing respective values (e.g., bits). During an example operation of the core selector 204, the core selector 204 identifies the X least significant bits (LSBs) of the hash for a data packet, where 2^{X}=M. In the example shown in FIG. 3, each of the flow timer array 302, the rebalancer array 308, and the flow register array 310 includes 16 memory locations for showing respective values (e.g., having index values 0-15, respectively), corresponding to the 4 least significant bits of the hash.

Further, the core selector 204 determines the value of the X least significant bits of the hash, and sets the corresponding memory locations of the flow time array 302 and the flow register array 310 to 1.

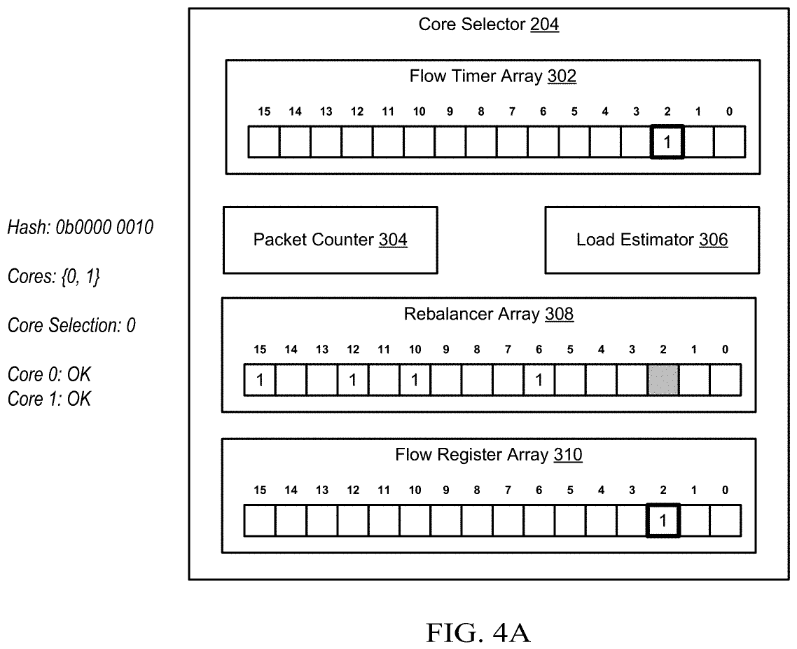

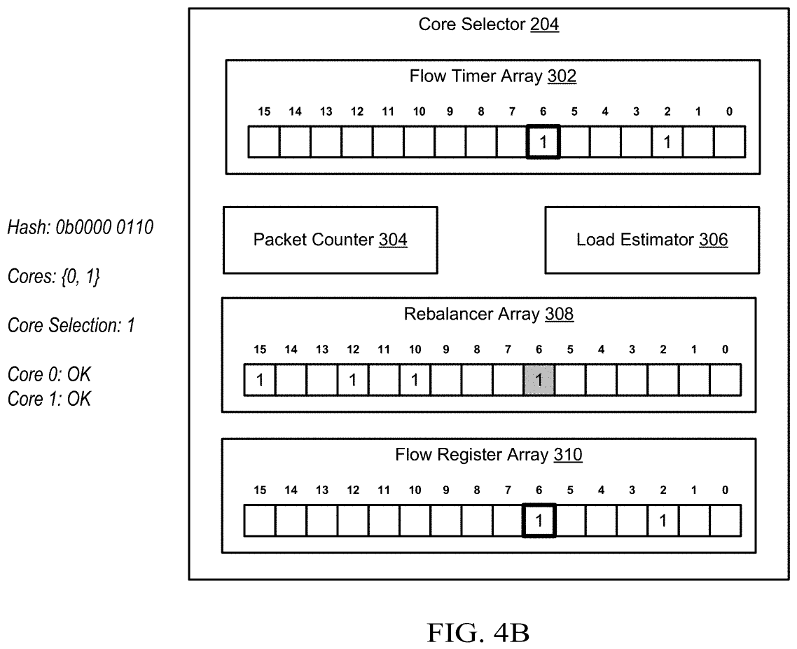

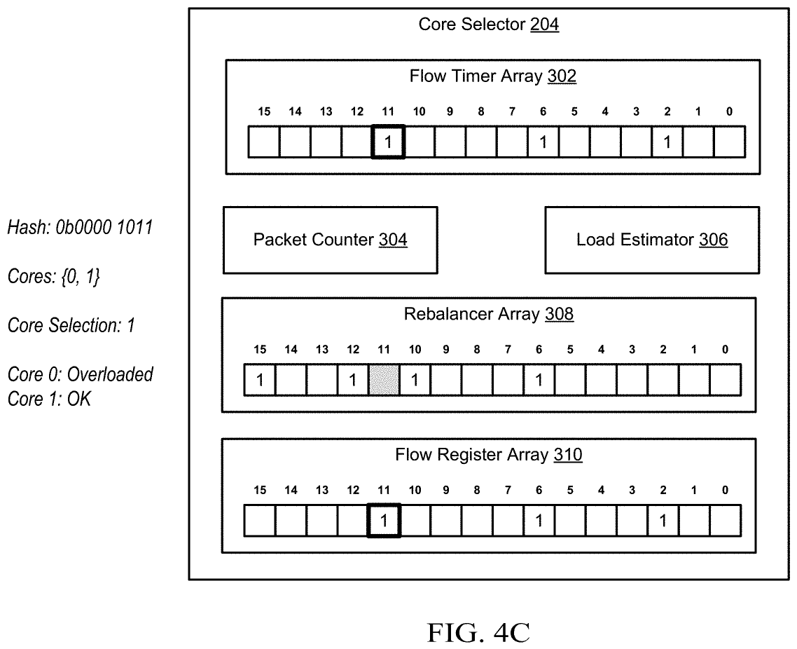

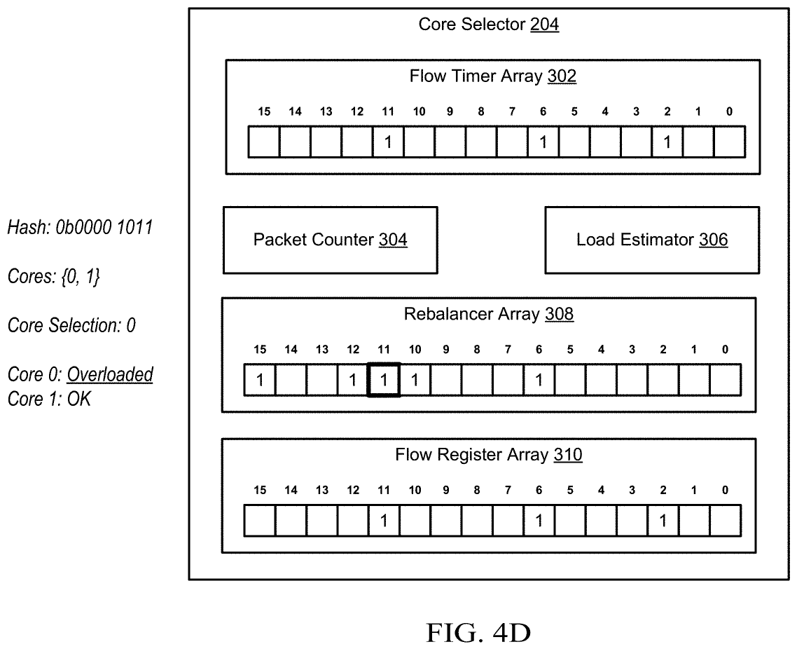

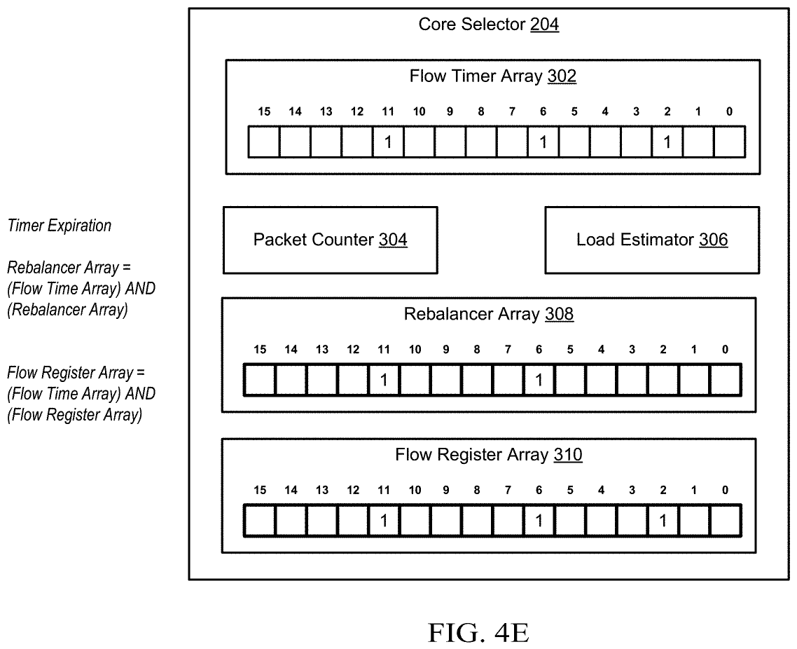

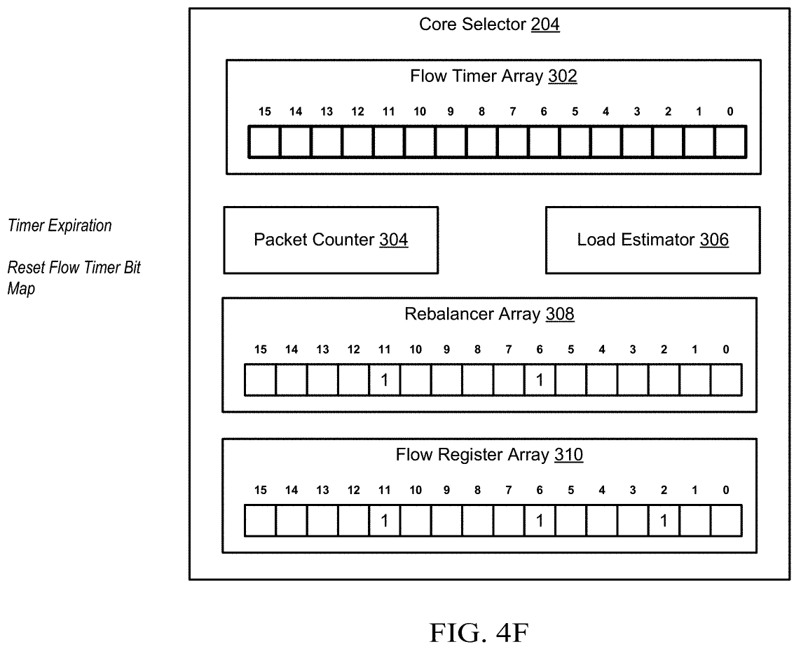

For instance, in the example shown in FIG. 4A, the load balancer 200 receives a first data packet, and generates a hash of 0b0000 0010 using the hash generator 202. Based on the 4 least significant bits of the hash (0b0010, corresponding to a decimal value of 2), the core selector 204 sets the memory locations having an index value of 2 in the flow timer array 302 and the flow register array 310 to 1.

Further, based on the hash value, the core selector 204 selects a candidate processing core for processing the data packet. For example, the core selector 204 can identify the Y least significant bits of the hash for a data packet, where 2^{Y}=N, and where N is the number of processing cores that are available for processing data packets in the wireless device.

For instance, in the example shown in FIG. 4A, the wireless device includes two processing cores (e.g., processing cores “0” and “1”). Accordingly, the core selector 204 can identify the least significant bit of the hash, and select a candidate processing core based on that bit. As an example, if the least significant bit is 0, the core selector 204 can select a processing core “0” as the candidate processing core. Alternatively, if the least significant bit is 1, the core selector 204 can select a processing core “1” as the candidate processing core. In this example, the core selector 204 selects the processor core “0” as the candidate processing core (e.g., as the least significant bit of the hash is 0).

Further, based on the rebalancer array 308, the core selector 204 can determine whether to use the candidate processing core for processing the data packet, or to instead use another processing core for processing the data packet. In particular, the core selector 204 can determine the value of the rebalancer array 308 at the corresponding memory location. If the value at that memory location is 0, the core selector 204 can select the previously determined candidate processing core for processing the data packet. However, if the value at that memory location is 1, the core selector 204 can select a different processing core for processing the data packet.

For instance, in the example shown in FIG. 4A, the data packet has a hash value of 0b000 0010, corresponding to an index value of 2. The value of the rebalancer array 308 at that memory location is 0. Accordingly, the core selector 204 can select the previously determined candidate processing core (e.g., the processing core “0”) for processing the data packet.

As another example, as shown in FIG. 4B, the load balancer 200 receives a second data packet, and generates a hash of 0b0000 0110 using the hash generator 202. Based on the 4 least significant bits of the hash (0b0110, corresponding to a decimal value of 6), the load balancer 200 sets the memory locations having an index value of 6 in the flow timer array 302 and the flow register array 310 to 1.

Further, based on the hash value, the core selector 204 selects a candidate processing core for processing the second data packet. In this example, the core selector 204 selects the processor core “0” as the candidate processing core (e.g., as the least significant bit of the hash is 0).

Further, based on the rebalancer array 308, the core selector 204 can determine whether to use the candidate processing core for processing the second data packet, or to instead use another processing core for processing the second data packet. In this example, the second data packet has a hash value of 0b000 0110, corresponding to an index value of 6. The value of the rebalancer array 308 at that memory location is 1. Accordingly, the core selector 204 can select an alternative processing core for processing the data packet. In this example, the wireless device only includes two processing cores. Thus, the core selector 204 can select the other processing core (e.g., the processing core “1”) for processing the second data packet.

As described above, the rebalancer array 308 can indicate to the core selector 204 whether to use the candidate processing core for processing a data packet (e.g., as determined based on the Y least significant bits of the hash), or to some another one of the processing cores for processing the data packet. The memory values of the rebalancer array 308 can be set based on a level of utilization of each of the processing cores.

As an example, as shown in FIG. 4C, the load balancer 200 receives a third data packet, and generates a hash of 0b0000 1011 using the hash generator 202. Based on the 4 least significant bits of the hash (0b1011, corresponding to a decimal value of 11), the load balancer 200 sets the memory locations having an index value of 11 in the flow timer array 302 and the flow register array 310 to 1.

Further, based on the hash value, the core selector 204 selects a candidate processing core for processing the third data packet. In this example, the core selector 204 selects the processor core “1” as the candidate processing core (e.g., as the least significant bit of the hash is 1).

Further, based on the rebalancer array 308, the core selector 204 can determine whether to use the candidate processing core for processing the third data packet, or to instead use another processing core for processing the third data packet. In this example, the second data packet has a hash value of 0b000 1011, corresponding to an index value of 11. The value of the rebalancer array 308 at that memory location is 0. Accordingly, the core selector 204 can select the previously determined candidate processing core (e.g., the processing core “1”) for processing the data packet.

However, in this example, the core selector 204 determines that the processing core “1” is experiencing a high level of utilization (e.g., the processing core “1” is “overloaded”). Accordingly, after assigning the third data packet to the processing core “1,” the core selector 204 can set the value of the rebalancer array 308, at the memory location having an index value of 11, to 1 (e.g., as shown in FIG. 4D). Accordingly, if another data packet is subsequently received having a hash value corresponding to an index value of 11 (e.g., having 0b1011 as the least significant bits), the core selector 204 can assign the data packet to another one of the processing cores.

In some implementations, the load balancer 200 can receive several data flows, each having one or more data packets. Further, the load balancer can assign each of the data packets of the same data flow to the same processing core. This can be beneficial, for example, in ensuring that the data packets are processed sequentially in time.

In some implementations, the core selector 204 can determine a utilization of each of the processing cores using the packet counter 304 and the loader estimator 306.

As an example, the packet counter 304 can be configured to count the number of packets that are assigned to each of the processing cores. This can be represented as PktCount(CoreIndex), where PktCount is the number of packets assigned to a processing core having an index CoreIndex.

Further, the load estimator 306 can be configured to estimate the load on each of the processing nodes based on the packet count for each processing core over time, such as using a windowed average.

As an example, the load estimator 306 can configured to estimate the load based on an exponential averaging of the load over time. For instance, the load on a processing core can be represented as CoreLoad(n, CoreIndex), where n is the upload epoch, and CoreIndex is the index value of the processing core.

Every nth update interval, the load estimator 306 can update the load based on PktCount. For example, the load can be updated using the relationship:

CoreLoad(n,CoreIndex)=a*CoreLoad(n−1,CoreIndex)+(1−a)*PktCount(CoreIndex) (Eq.1).

Once CoreLoad is updated, PktCount(CoreIndex) is reset.

In some implementations, if the utilization of a processing core exceeds a particular threshold level, the load estimator 306 can determine that the processing core is “overloaded.” Based on this determination, the core selector 204 can selectively modify one or more values of the rebalancer array 308 corresponding to that processing core (e.g., as described with reference to FIGS. 4C and 4D), such that new data packets are more likely to be assigned to other processing cores (e.g., processing cores experiencing comparatively lower levels of utilization).

In practice, the threshold level is a tunable value, and can be selected empirically. Further, the values of a and n are also tunable values, and also can be selected empirically. As an example, n can be equal to 10 ms, and a can be equal to 10%. In practice, others values are also possible, depending on the implementation.

In some implementations, each of the processing cores can be associated with the same threshold level. For example, for each of the processing cores, if the utilization of that processing core exceeds a common threshold level, the core selector 204 can determine that the processing core is overloaded.

In some implementations, at least some of the processing cores can be associated with different respective threshold levels. This can be beneficial, for example, if certain processing cores have different processing capabilities. For example, processing cores having greater processing capabilities (e.g., faster clock speed, access to more memory and/or cache, etc.) can be associated with a higher threshold level for determining overloading, whereas processing cores having lesser processing capabilities (e.g., slower clock speed, access to less memory and/or cache, etc.) can be associated with a lower threshold level for determining overloading

In some implementations, at least some of the processing cores can be associated with dynamically threshold levels that vary depend on the utilization of the processing cores for performing tasks other than a processing of data packets. For example, if a processing core is 60% utilized to perform “housingkeeping” operations that are not directly associated with the processing of data packets (e.g., memory management operations, etc.), the threshold value for that processing core can be set to a first value. Further, if the processing core is subsequently 70% utilized to perform housekeeping operations, the threshold value for that processing can be set to a second lower value (e.g., reflecting that the processing core has fewer available resources to process data packets before becoming overloaded. Similarly if the processing core is subsequently 50% utilized to perform housekeeping operations, the threshold value for that processing can be set to a third higher value (e.g., reflecting that the processing core has greater available resources to process data packets before becoming overloaded).

The techniques described above are beneficial, for example, in enabling the core selector 204 to estimate the load on each of the processing cores in a quick and efficient manner. For example, the techniques described above rely on a counting of packets over time and an exponential averaging of a load over time, which does not require a large computational overhead.

Further, the core selector 204 can periodically reset memory locations in the rebalancer array 308 and the flow register array 310 to 0. This can be beneficial, for example, in removing stale data packets from the arrays.

As an example, the core selector 204 can maintain a timer (e.g., having a time interval t). Upon expiration of the timer, the core selector 204 can (i) perform a bitwise logical AND operation between the flow timer array 302 and the rebalancer array 308, and (ii) perform a bitwise logical AND operation between the flow timer array 302 and the flow register array 310. This can be represented as:

Rebalancer Array=(Flow Time Array)AND(Rebalancer Array) (Eq.2),

Flow Register Array=(Flow Time Array)AND(Flow Register Array) (Eq.3).

To illustrate, in the example shown in FIG. 4E, the bitwise logical AND operations result in (i) the rebalancer array 308 having all zero values, except at the memory locations having index values of 6 and 11, and (ii) the flow register array 310 having all zero values, except at the memory locations having index values of 2, 6, and 11.

Further, subsequent to performing the location AND operations, the core selector 204 can reset the flow timer array 302 at each of its memory locations to 0. To illustrate, in the example shown in FIG. 4F, the flow timer array 302 at each of its memory locations to 0.

In practice, the time interval t of the timer is a tunable value, and can be selected empirically. As an example, t can have a value in a range from 0.1 seconds to 10 seconds. Other values for t are also possible, depending on the implementation.

In general, the processes shown in FIGS. 4A-4D can be repeated for each newly received data packet (e.g., to assign data packets to respective processing cores). Further, the processes shown in FIGS. 4E and 4F can be repeated periodically (e.g., upon expiration of a timer) to periodically reset each of the flow timer array 302, the rebalancer array 308, the flow register array 310, and/or portions thereof to 0.

In the examples shown in FIGS. 3 and 4A-4F, the core selector 204 includes arrays each having 16 memory locations. However, in practice, the core selector 204 can include arrays having any number of memory locations (e.g., 16, 32, 64, 128, 256, etc.).

Further, in some implementations, the core selector 204 can dynamically adjust the size each of its arrays, such as to facilitate the processing of different numbers of data flows. As an example, to accommodate the processing of an increased number of data flows, the core selector 204 can dynamically increase the number of memory locations of each of its arrays. As another example, to accommodate the processing of a reduced number of data flows in a more efficient manner, the core selector 204 can dynamically reduce the number of memory locations of each of its arrays. In some implementations, a processor of the electronic device (e.g., an application processor) can signal an expected number of data flows to the core selector 204, and the core selector 204 can dynamically adjust the size of its arrays based on the received information.

Further, in some implementations, the core selector 204 can dynamically adjust the size of its arrays based on other factors, such as an expected arrival rate of data flows and/or an expected life time of data flows (e.g., the time between the beginning and end of the data flows). As an example, in anticipation of processing data flows at an increased rate, the core selector 204 can dynamically increase the number of memory locations of each of its arrays. As another example, in anticipation of processing data flows at a decreased rate, the core selector 204 can dynamically reduce the number of memory locations of each of its arrays. As an example, in anticipation of processing data flows having longer life times, the core selector 204 can dynamically increase the number of memory locations of each of its arrays. As another example, in anticipation of processing data flows having shorter life times, the core selector 204 can dynamically reduce the number of memory locations of each of its arrays. In some implementations, a processor of the electronic device (e.g., an application processor) can signal an expected rates and/or life times of data flows to the core selector 204, and the core selector 204 can dynamically adjust the size of its arrays based on the received information.

Further, the examples shown in FIGS. 3 and 4A-4F, each of the memory locations stores a single respective bit. However, in practice, each of the memory locations can store any number of bits. As an example, at least some of the memory locations can be used to store two, three, four, or more bits. In these implementations, the arrays may instead be referred to as bit maps (e.g., a flow timer bit map, a rebalancer bit map, and/or a flow register bit map).

Correspondingly, the examples shown in FIGS. 3 and 4A-4F describe the core selector 204 as identifying the 4 least significant bits in a hash for a data packet (e.g., corresponding to 16 memory locations). However, in practice, the core selector 204 can identify any number of least significant bits in a hash of a data packet (e.g., 4, 5, 6, 7, 8, or any other number) to determine an index number for the arrays.

Further, in the examples shown in FIGS. 4A-4F, the core selector 204 selects from among two processing cores of a wireless device for processing data packets. However, in practice, the core selector 204 can select from among any number of processing cores (e.g., 2, 4, 8, 16, 32, etc.). For instance, as described above, the core selector 204 can identify the Y least significant bits of the hash for a data packet, where 2^{Y}=N, and where N is the number of processing cores that are available for processing data packets in the wireless device.

To illustrate, if a wireless device includes four processing cores (e.g., processing cores “0,” “1,” “2,” and “3”), the 2 least significant bits of a hash value can be used to select a candidate processing core from among these four processing cores. For example, the value 0b00 can correspond to the selection of the processing core “0” as a candidate processing core, the value 0b01 can correspond to the selection of the processing core “1” as a candidate processing core, the value 0b10 can correspond to the selection of the processing core “2” as a candidate processing core, the value 0b11 can correspond to the selection of the processing core “3” as a candidate processing core,

Further, as described above, the core selector 204 uses the rebalancer array 308 to determine whether to select a candidate processing core (e.g., as determined based on the Y least significant bits of a hash value) or some other processing core. As described above, in implementations in which a wireless device includes two processing cores, a value of 0 in the rebalancer array can indicate that the core selector 204 should select the candidate processing core, and a value of 1 in the rebalancer array can indicate that the core selector 204 should select the other candidate processing core.

In implementations in which a wireless device includes more than two processing cores, the core selector 204 can select a processing code based on the following generalized relationship:

SelectedCore=(Hash+Rebalancer(Hash))% Number of Cores (Eq. 4),

where Hash is the hash of a data packet, Rebalancer(Hash) is the value of the rebalancer array at the memory location corresponding to the hash (e.g., the memory location having an index value corresponding to the X least significant bits of the hash), Number of Cores is the number of processing cores of the wireless device, and % is the modulo operation.

For example, if a data packet has a hash value having two least significant bits 0b01, the core selector 204 can initially selected a processing in core “1” as a candidate processing core. However, if the corresponding memory location of the rebalancer array has a value of b11, the relationship above would yield:

SelectedCore=(0b01+0b11)%0b100=0b0

Accordingly, the core selector 204 can select a processing in core “0” for processing the data packet (as indicated by the rebalancer array 310 and the relationship above), instead of the candidate processing core “0” (as indicated by the two least significant bits of a hash value).

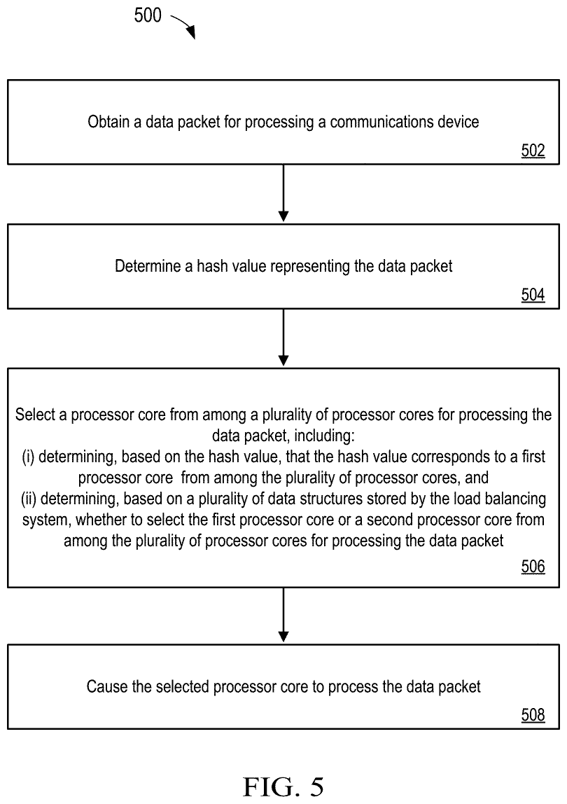

FIG. 5 shows an example process 500 for processing data packets using a communication device. The process 500 can be performed for example, one or more of the components of the system 100 shown in FIG. 1 (e.g., the first electronic device 102a and/or the second electronic device 102b) using the techniques described herein. In some implementations, process 500 can be performed at least in part by a load balancer 200 (e.g., as shown in FIG. 2) that is included in one or more of the electronic devices (e.g., included in a transceiver of an electronic device and/or some other component thereof). In some implementations, the process 500 can be performed, at least in part, by a baseband processor of a wireless radio of the communications device.

In the process 500, a system obtains a data packet for processing (block 502).

Further, the system determines a hash value representing the data packet (block 504).

Further, the system selects a processor core from among a plurality of processor cores for processing the data packet (block 506). The system selects the processor core, at least in part, by determining based on the hash value, that the hash value corresponds to a first processor core from among the plurality of processor cores. Further, the system determines, based on a plurality of data structures stored by the load balancing system, whether to select the first processor core or a second processor core from among the plurality of processor cores for processing the data packet.

In some implementations, the system can determine that the hash value corresponds to the first processor core, at least in part, by determining a portion of the hash value, and determining that the portion of the hash value corresponds to the first processor core.

In some implementations, the portion of the hash value can be a specified number of least significant bits of the hash value. For example, the portion of the hash value can be the least significant bit of the hash value. As another example, the portion of the hash value can be the two least significant bits of the hash value.

Further, the systems causes the selected processor core to process the data packet (block 508). In some implementations, causing the selected processor core to process the data packet can include providing the data packet to a connection ring associated with the selected processor core.

In some implementations, the system can determine whether to select the first processor core or the second processor core for processing the data packet, at least in part, by determining that the portion of the hash value corresponds to a first data position, and setting a first value at the first data position of a first data structure to 1. The first data structure is selected from among the plurality of data structures. For example, the first data structure can be a flow register array (e.g., as shown and described with reference to FIGS. 3 and 4A-4F).

In some implementations, the system can determine whether to select the first processor core or the second processor core for processing the data packet, at least in part, by determining a second value at the first data position of a second data structure, and selecting the first processor core or the second processor core based on the second value. The second data structure can be selected from among the plurality of data structures. For example, the second data structure can be a rebalancer array (e.g., as shown and described with reference to FIGS. 3 and 4A-4F).

In some implementations, the system can determine whether to select the first processor core or the second processor core for processing the data packet, at least in part, by determining that the second value is 0, and in response, selecting the first data processor core for processing the data package.

In some implementations, the system can determine whether to select the first processor core or the second processor core for processing the data packet, at least in part, by determining that the second value is non-zero, and in response, selecting the second data processor core for processing the data package.

In some implementations, the system can determine whether to select the first processor core or the second processor core for processing the data packet, at least in part, by determining that a first utilization of the first processor core has exceeded a threshold value, and in response, setting the second value at the first data position of the second data structure to 1.

In some implementations, the first utilization of the first processor core can be determined based on a number of data packets assigned by the load balancing system to the first processor core over a sliding time window.

In some implementations, the first utilization of the first processor core can be determined based on a windowed average of the number of data packets assigned by the load balancing system to the first processor core over the sliding time window.

In some implementations, the threshold value can vary based on a second utilization of the first processor core. For example, the first utilization can correspond to one or operations performed by the first processor core to process of data packets, whereas the second utilization can correspond to one or operations performed by the first processor core other than a processing of data packets (e.g., “housekeeping” tasks, memory management, or other operations not directly associated with the processing of data packets).

In some implementations, the threshold value can be common to each of the processing cores.

In some implementations, the threshold value can be specific to a subset of the processing cores.

In some implementations, each of the processor cores can be associated with a respective threshold value. where the threshold value that is associated with each of the processor cores is determined based on a processing capability of that processor core.

In some implementations, the process 500 can further include setting a third value at the first data position of a third data structure to 1. The third data structure can be selected from among the plurality of data structures. For example, the third data structure can be a flow timer array (e.g., as shown and described with reference to FIGS. 3 and 4A-4F).

In some implementations, the process 500 can further include (i) periodically performing a first logical AND operation between the third data structure and the first data structure, and (ii) periodically performing a second logical AND operation between the third data structure and the second data structure.

In some implementations, the plurality of data structures can include a plurality of bit maps. In some implementations, the plurality of data structures can include a plurality of data arrays. In some limitations, the system can dynamically adjust a size of at least some of the bit maps and/or data arrays.

FIG. 6 is a block diagram of an example device architecture 600 for implementing the features and processes described in reference to FIGS. 1-5. For example, the architecture 600 can be used to implement the first electronic device 102a and/or the second electronic device 102b. The architecture 600 may be implemented in any device for generating the features described in reference to FIGS. 1-5, including but not limited to desktop computers, server computers, portable computers, smart phones, tablet computers, game consoles, wearable computers, set top boxes, media players, smart TVs, and the like.

The architecture 600 can include a memory interface 602, one or more data processor 604, one or more data co-processors 674, and a peripherals interface 606. The memory interface 602, the processor(s) 604, the co-processor(s) 674, and/or the peripherals interface 606 can be separate components or can be integrated in one or more integrated circuits. One or more communication buses or signal lines may couple the various components.

The processor(s) 604 and/or the co-processor(s) 674 can operate in conjunction to perform the operations described herein. For instance, the processor(s) 604 can include one or more central processing units (CPUs) that are configured to function as the primary computer processors for the architecture 600. As an example, the processor(s) 604 can be configured to perform generalized data processing tasks of the architecture 600. Further, at least some of the data processing tasks can be offloaded to the co-processor(s) 674. For example, specialized data processing tasks, such as processing motion data, processing image data, encrypting data, and/or performing certain types of arithmetic operations, can be offloaded to one or more specialized co-processor(s) 674 for handling those tasks. In some cases, the processor(s) 604 can be relatively more powerful than the co-processor(s) 674 and/or can consume more power than the co-processor(s) 674. This can be useful, for example, as it enables the processor(s) 604 to handle generalized tasks quickly, while also offloading certain other tasks to co-processor(s) 674 that may perform those tasks more efficiency and/or more effectively. In some cases, a co-processor(s) can include one or more sensors or other components (e.g., as described herein), and can be configured to process data obtained using those sensors or components, and provide the processed data to the processor(s) 604 for further analysis.

Sensors, devices, and subsystems can be coupled to peripherals interface 606 to facilitate multiple functionalities. For example, a motion sensor 610, a light sensor 612, and a proximity sensor 614 can be coupled to the peripherals interface 606 to facilitate orientation, lighting, and proximity functions of the architecture 600. For example, in some implementations, a light sensor 612 can be utilized to facilitate adjusting the brightness of a touch surface 646. In some implementations, a motion sensor 610 can be utilized to detect movement and orientation of the device. For example, the motion sensor 610 can include one or more accelerometers (e.g., to measure the acceleration experienced by the motion sensor 610 and/or the architecture 600 over a period of time), and/or one or more compasses or gyros (e.g., to measure the orientation of the motion sensor 610 and/or the mobile device). In some cases, the measurement information obtained by the motion sensor 610 can be in the form of one or more a time-varying signals (e.g., a time-varying plot of an acceleration and/or an orientation over a period of time). Further, display objects or media may be presented according to a detected orientation (e.g., according to a “portrait” orientation or a “landscape” orientation). In some cases, a motion sensor 610 can be directly integrated into a co-processor 674 configured to processes measurements obtained by the motion sensor 610. For example, a co-processor 674 can include one more accelerometers, compasses, and/or gyroscopes, and can be configured to obtain sensor data from each of these sensors, process the sensor data, and transmit the processed data to the processor(s) 604 for further analysis.

Other sensors may also be connected to the peripherals interface 606, such as a temperature sensor, a biometric sensor, or other sensing device, to facilitate related functionalities. As an example, as shown in FIG. 6, the architecture 600 can include a heart rate sensor 632 that measures the beats of a user's heart. Similarly, these other sensors also can be directly integrated into one or more co-processor(s) 674 configured to process measurements obtained from those sensors.

A location processor 615 (e.g., a GNSS receiver chip) can be connected to the peripherals interface 606 to provide geo-referencing. An electronic magnetometer 616 (e.g., an integrated circuit chip) can also be connected to the peripherals interface 606 to provide data that may be used to determine the direction of magnetic North. Thus, the electronic magnetometer 616 can be used as an electronic compass.

A camera subsystem 620 and an optical sensor 622 (e.g., a charged coupled device [CCD] or a complementary metal-oxide semiconductor [CMOS] optical sensor) can be utilized to facilitate camera functions, such as recording photographs and video clips.

Communication functions may be facilitated through one or more communication subsystems 624. The communication subsystem(s) 624 can include one or more wireless and/or wired communication subsystems. For example, wireless communication subsystems can include radio frequency receivers and transmitters and/or optical (e.g., infrared) receivers and transmitters. As another example, wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data.

The specific design and implementation of the communication subsystem 624 can depend on the communication network(s) or medium(s) over which the architecture 600 is intended to operate. For example, the architecture 600 can include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, NFC and a Bluetooth™ network. The wireless communication subsystems can also include hosting protocols such that the architecture 600 can be configured as a base station for other wireless devices. As another example, the communication subsystems may allow the architecture 600 to synchronize with a host device using one or more protocols, such as, for example, the TCP/IP protocol, HTTP protocol, UDP protocol, and any other known protocol.

An audio subsystem 626 can be coupled to a speaker 628 and one or more microphones 630 to facilitate voice-enabled functions, such as voice recognition, voice replication, digital recording, and telephony functions.

An I/O subsystem 640 can include a touch controller 642 and/or other input controller(s) 644. The touch controller 642 can be coupled to a touch surface 646. The touch surface 646 and the touch controller 642 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with the touch surface 646. In one implementations, the touch surface 646 can display virtual or soft buttons and a virtual keyboard, which can be used as an input/output device by the user.

Other input controller(s) 644 can be coupled to other input/control devices 648, such as one or more buttons, rocker switches, thumb-wheel, infrared port, USB port, and/or a pointer device such as a stylus. The one or more buttons (not shown) can include an up/down button for volume control of the speaker 628 and/or the microphone 630.

In some implementations, the architecture 600 can present recorded audio and/or video files, such as MP3, AAC, and MPEG video files. In some implementations, the architecture 600 can include the functionality of an MP3 player and may include a pin connector for tethering to other devices. Other input/output and control devices may be used.

A memory interface 602 can be coupled to a memory 650. The memory 650 can include high-speed random access memory or non-volatile memory, such as one or more magnetic disk storage devices, one or more optical storage devices, or flash memory (e.g., NAND, NOR). The memory 650 can store an operating system 652, such as Darwin, RTXC, LINUX, UNIX, OS X, WINDOWS, or an embedded operating system such as VxWorks. The operating system 652 can include instructions for handling basic system services and for performing hardware dependent tasks. In some implementations, the operating system 652 can include a kernel (e.g., UNIX kernel).

The memory 650 can also store communication instructions 654 to facilitate communicating with one or more additional devices, one or more computers or servers, including peer-to-peer communications. The communication instructions 654 can also be used to select an operational mode or communication medium for use by the device, based on a geographic location (obtained by the GPS/Navigation instructions 668) of the device. The memory 650 can include graphical user interface instructions 656 to facilitate graphic user interface processing, including a touch model for interpreting touch inputs and gestures; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GPS/Navigation instructions 669 to facilitate GPS and navigation-related processes; camera instructions 670 to facilitate camera-related processes and functions; and other instructions 672 for performing some or all of the processes described herein.

Each of the above identified instructions and applications can correspond to a set of instructions for performing one or more functions described herein. These instructions need not be implemented as separate software programs, procedures, or modules. The memory 650 can include additional instructions or fewer instructions. Furthermore, various functions of the device may be implemented in hardware and/or in software, including in one or more signal processing and/or application specific integrated circuits (ASICs).

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
obtaining, by a system, a data packet for processing;
determining, by the system, a hash value representing the data packet;
selecting, by the system, a processor core from among a plurality of processor cores for processing the data packet, wherein selecting the processor core comprises:
determining, based at least in part on the hash value, that the hash value corresponds to a first processor core from among the plurality of processor cores, and
determining, based on a plurality of data structures stored by the system, whether to select the first processor core or a second processor core from among the plurality of processor cores for processing the data packet; and
causing, by the system, the selected processor core to process the data packet.

2. The method of claim 1, wherein determining that the hash value corresponds to the first processor core comprises:
determining a portion of the hash value, and
determining that the portion of the hash value corresponds to the first processor core.

3. The method of claim 2, wherein the portion of the hash value is a specified number of least significant bits of the hash value.

4. The method of claim 3, wherein the portion of the hash value is the least significant bit of the hash value.

5. The method of claim 3, wherein the portion of the hash value is the two least significant bits of the hash value.

6. The method of claim 2, wherein determining whether to select the first processor core or the second processor core for processing the data packet comprises:
determining that the portion of the hash value corresponds to a first data position, and
setting a first value at the first data position of a first data structure to 1, wherein the first data structure is selected from among the plurality of data structures.

7. The method of claim 6, wherein determining whether to select the first processor core or the second processor core for processing the data packet comprises:
determining a second value at the first data position of a second data structure, wherein the second data structure is selected from among the plurality of data structures, and
selecting the first processor core or the second processor core based on the second value.

8. The method of claim 7, wherein determining whether to select the first processor core or the second processor core for processing the data packet comprises:
determining that the second value is 0, and
responsive to determining that the second value is 0, selecting the first data processor core for processing the data package.

9. The method of claim 7, wherein determining whether to select the first processor core or the second processor core for processing the data packet comprises:
determining that the second value is non-zero, and
responsive to determining that the second value is non-zero, selecting the second data processor core for processing the data package.

10. The method of claim 1, wherein determining whether to select the first processor core or the second processor core for processing the data packet comprises:
determining that a first utilization of the first processor core has exceeded a threshold value, and
responsive to determining to that the first utilization of the first processor core has exceeded the threshold value, setting the second value at the first data position of the second data structure to 1.

11. The method of claim 10, wherein the first utilization of the first processor core is determined based on a number of data packets assigned by the system to the first processor core over a sliding time window.

12. The method of claim 11, wherein the first utilization of the first processor core is determined based on a windowed average of the number of data packets assigned by the system to the first processor core over the sliding time window.

13. The method of claim 10, wherein the threshold value varies based on a second utilization of the first processor core, wherein the second utilization corresponds to one or operations performed by the first processor core other than a processing of data packets.

14. The method of claim 10, wherein the threshold value is common to each of the processing cores.

15. The method of claim 10, wherein the threshold value is specific to a subset of the processing cores.

16. The method of claim 10, wherein each of the processor cores is associated with a respective threshold value, and wherein the threshold value that is associated with each of the processor cores is determined based on a processing capability of that processor core.

17. The method of claim 7, further comprising:
setting a third value at the first data position of a third data structure to 1, wherein the third data structure is selected from among the plurality of data structures.

18. The method of claim 1, further comprising:
periodically performing a first logical AND operation between the third data structure and the first data structure, and
periodically performing a second logical AND operation between the third data structure and the second data structure.

19. The method of claim 1, wherein the plurality of data structures comprises a plurality of bit maps.

20. The method of claim 1, wherein the plurality of data structures comprises a plurality of data arrays.

21. The method of claim 20, further comprising:
dynamically adjusting a size of at least some of the data arrays.

22. The method of claim 1, wherein the system is implemented, at least in part, by a baseband processor of a wireless radio of a communications device.

23. The method of claim 1, wherein causing the selected processor core to process the data packet comprises:
providing the data packet to a connection ring associated with the selected processor core.

24. A system comprising:
one or more processors; and
memory storing instructions that when executed by the one or more processors, cause the one or more processors to perform operations comprising:
obtaining a data packet for processing;
determining a hash value representing the data packet;
selecting a processor core from among a plurality of processor cores for processing the data packet, wherein selecting the processor core comprises:
determining, based at least in part on the hash value, that the hash value corresponds to a first processor core from among the plurality of processor cores, and
determining, based on a plurality of data structures stored by the system, whether to select the first processor core or a second processor core from among the plurality of processor cores for processing the data packet; and
causing the selected processor core to process the data packet.

25. One or more non-transitory, computer-readable storage media having instructions stored thereon, that when executed by one or more processors, cause the one or more processors to perform operations comprising:
obtaining a data packet for processing;
determining a hash value representing the data packet;
selecting a processor core from among a plurality of processor cores for processing the data packet, wherein selecting the processor core comprises:
determining, based at least in part on the hash value, that the hash value corresponds to a first processor core from among the plurality of processor cores, and
determining, based on a plurality of data structures stored by the system, whether to select the first processor core or a second processor core from among the plurality of processor cores for processing the data packet; and
causing the selected processor core to process the data packet.
